(19) United States
(12) Patent Application Publication
(10) Pub. No.: US 2016/0239832 A1
(43) Pub. Date: Aug. 18, 2016

(54) PAYMENT SYSTEM

(71) Applicant: GARY J KNORR, NORTH LIBERTY, IA (US)

(72) Inventor: GARY J KNORR, NORTH LIBERTY, IA (US)

(21) Appl. No.: 14/622,863

(22) Filed: Feb. 14, 2015

(51) Int. Cl. G06Q 20/36; G06Q 20/32; H04L 29/06; G06Q 20/38

(52) U.S. Cl. CPC G06Q 20/3672; G06Q 20/38215; G06Q 20/32; H04L 63/02; H04L 63/1466

(57) ABSTRACT

A payment system can include removal from the Grid (electronic network) of a person's identity for the purpose of purchased transactions. The payment system can use a Digitized 2D Graphical representation of the person's “Alias Identity” for the purpose of identification and authorization of a purchase transaction. The system can store securely off an electronic network a personal identity for a payment process. The payment system can process a payment in a secure manner and forward it to a merchant.

### FIELD OF THE INVENTION

The Invention relates generally to the field of electronic payment systems.

### BACKGROUND

Today, it is almost a daily occurrence that companies that are accepting payments, large and small, are reporting identity theft of their customers. The hackers are hacking the company's systems to steal their valued customer's identity. The identity theft disrupts the payment processing chain and all the participants in the chain are harmed financially and structurally. There is a need for a company to create a payment system that will secure the consumer's identity while providing upstream protection for all the party's processing the financial transaction.

Companies today try to prevent identity theft after it occurs, or they make the merchant responsible for accepting fraudulent transactions when they occur or the bank that is responsible for replacing stolen money into the customer's account when money goes missing from identity theft. The consumer is also left picking up the pieces from these fraudulent transactions spending hundreds to thousands of dollars to fix the identity theft.

Accordingly, there is a need for a new and incredibly secure payment system.

### SUMMARY OF THE INVENTION

In one aspect of the present invention, a method of encrypting an identity for financial transactions includes creating an alias for the identity on an alias computer server with both a graphical component and a textual component, creating a hardware firewall between an internet server and the alias computer server; creating a software firewall between the internet server and the alias computer server; creating air gaps between the internet server and the alias computer server; utilizing the alias in financial transactions with a financial institution; creating the graphical component as a quick response token; sending the quick response token with a mobile device to a merchant; displaying the alias for the identity when the merchant scans the quick response token; and the merchant visually approving the alias.

In another aspect of the invention, a system of encrypting an identity for financial transactions includes an alias computer server configured to create an alias for the identity with both a graphical component and a textual component; a threat server configured to encrypt the alias with splinters of information from random events through a plurality of electronic devices; a hardware firewall between an internet server and the threat computer server; a software firewall between the internet server and the threat computer server; and a plurality of air gaps between the internet server and the alias computer server.

In another aspect of the present invention, a system of encrypting an identity for financial transactions including an email server configured to collect information regarding the identity; an alias computer server configured to create an alias for the identity with both a graphical component and a textual component, a threat server configured to encrypt the alias with splinters of information from random events through a plurality of electronic devices; a hardware firewall and a software firewall disposed between an internet server and the threat server; a transaction server configured to complete a financial transaction request received from the alias server; and at least one air gap between the internet server and the threat server, and at least one air gap disposed between the alias server and the transaction server.

These features are described further in the description below, in the drawing, and in the claims.

### DESCRIPTION OF THE FIGURES

FIG. 1 shows a perspective view of an embodiment of the Invention.

### DETAILED DESCRIPTION

The following description is not intended to limit the scope of the Invention, but to generally illustrate the Invention. The Invention belongs to the fields of payment systems and fraud protection.

The Invention is a system and method for systematic removal from the Grid (electronic network) of a person's identity for the purpose of a payment transaction. The Invention enables a person to join our company which uses systems and algorithms and Intelligent Robotic Devices 124 to protect the person's identity and systematically create an “Identicon” of a person for the purpose of creating payments of purchased goods and services from member companies. The “Identicon” is a Digitized 2D Graphical representation of the person which becomes the “Alias Identity” that is stored off the grid by Intelligent Robotic 124 methods and is used to make payment transactions. The company using the “Alias Identity” creates the payment off grid and forwards it to the bank for processing to the member company for payment in a secure FTP 136 behind a hardware Firewall 134.

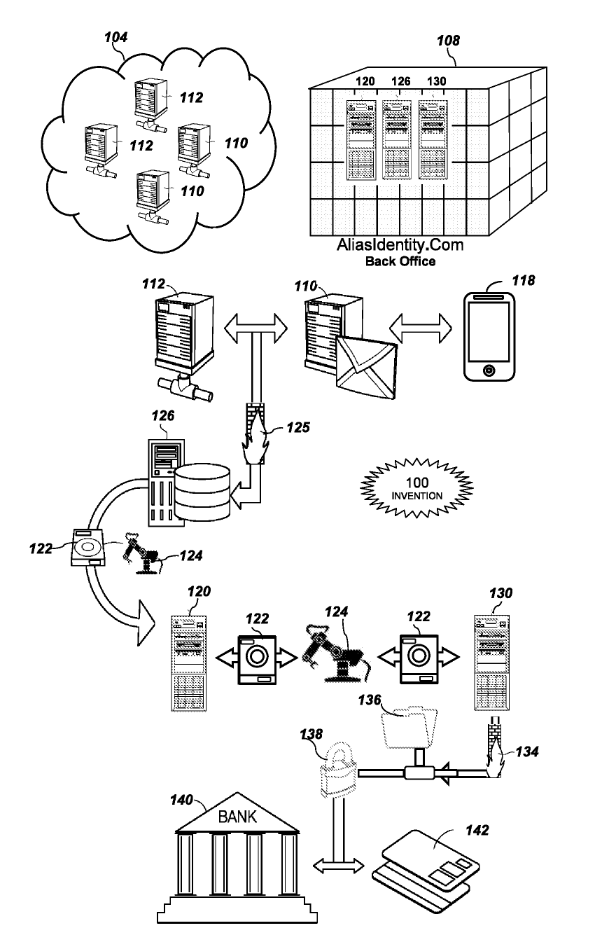

As shown in FIG. 1, a preferred embodiment exemplifying the best practice in a payment system 100 which can include an internet Exchange Server 112, a Mail Server 110, a Threat Server 126, a Alias Process Server 120 and a

Transaction Process Server 130. A customer can go to an internet address, such as “aliasidentity.com”, to open an account where they will only be asked to enter their name and email address. Email links will then be sent to the customer from the Mail Server 110 or messages from personal communication devices like cell phone 118 to collect the balance of customer information. The information will include personal contact information, creation of a new password, and security questions to answer. The information can be sent to an Exchange Server 112. The information can be merged with the collected data and then passed thru the Threat Server 126 and then on a hot swappable hard drive. The drive can then be scanned for virus and intrusions. Once scanned, the drive can then be removed and plugged into the Alias Process Server 120.

A customer creation process may include retrieving the customer's name and email address. The customer then hits a submit button. A request to create the customer is sent to the Exchange Server 112. A series of emails and text messages are created and that starts a process to gather “Data Splinters” that will be encrypted and stored on the Exchange Server 112 until the “Data Splinters” are queried by the Alias Process Server 120. Data Splinters are further explained below.

An “Off Grid Alias Identity” is created for use by a consumer independent of a financial institution. A consumer can pay for purchase of products and services with a secure and personally verified transaction, to a member company of “aliasidentity.com” using secure QR payment tokens which displays a physical representation of the customer (“Identicon”) and a encrypted payment code.

A person's identity and financial information is collected with “Data Splinters” via Email, Social Media and Cell Phone text messaging, which are encrypted and stored off grid through an Air Gap 122, Intelligent Robotic Process 124. An Air Gap Process 122 ensures physical isolation of a secure computer network from unsecured networks. During the process an “Alias Identity” is created for the person's real identity that can be used in the regular course of business to securely purchase goods and services. With the “Invention” goods and services can be purchased through use of an absolutely secure business process authorized by a secure “QR Token” and verified “Identicon” and then processed for payment. A “QR Token” is a pattern arranged in a square grid that is used to store account information. The business transaction is converted “Off Grid” back into the consumer's real identity. “Off Grid” means isolation from the Internet 104 or any other contact outside a system. The financial process is then completed.

The Invention 100 can systematically gather (Exchange Server 112), hide (Alias Process Server 120) and recreate (Alias Process Server 120 and Transaction Process Server 130) a new identity for the consumer one Splinter of data at a time. The customer profile is then stored behind the Air Gap Process 122 using an Air Gap device 122 by removing randomly collected information from the Alias Process Server 120 and Robotically 124 transfer it to the Transaction

Process Server 130 which is isolated from any connection with the Internet or any other device that may be subject to intrusions. The customer is given a totally new identity which is meaningless to anyone attempting to maliciously use the person's identity.

The Exchange Server 112 serves at least several functions within the process. First, the Exchange Server 112 is where an internet company stores its information and the internet company markets from. Marketing is done to financial institutions that become the vehicle for the process, merchants who become the access point to the process and the consumer who chooses to use the process to protect their identity with the merchant through the financial organizations.

The Invention seeks to resolve the issues of identity theft before it occurs by creating a digital representation of the customer that replaces the customer's identity with an “Identicon”. The “Identicon” will become part of a “QR Token” and the “QR Token” will become a graphic representation of the customer in a one time payment authorization that the merchant can securely take and transmit for secure payment into their deposit account.

The “Identicon” can make payment to the member Merchant either in cash through a deposit account or via credit card that is authorized by the bank to the customer. An “Identicon” is good for a one time only transaction by a user, for example, on a consumer's smart phone. Once a transaction is complete and authorized by the processing center the transaction is complete and cannot be regenerated or reused at any other merchant. The authentication is authorized by the consumer and verified by the merchant by visually matching a key code and a visual identity of the customer through a photo match of the customer via the system sent to the merchant's home page on the Exchange Server 112.

When a consumer accepts the company's offering to create an off grid identity, the Alias Process Server 120 systematically collects or triggers the collection of Splinters of information from the consumer. These Splinters of information are randomly queried through multiple Medias and are transmitted to the Exchange Server 112. The Exchange Server 112 is responsible for the gathering and transmittal of the information to the Threat Server 126 that is protected by a firewalls and hacker threat detection services. The “Exchange” Server 112 creates random queries to the consumer via email, social media and text messaging. When the random information is gathered, a key is assigned to each Splinter of information and methodically works its way through our process until it becomes part of a completed customer profile on our Transaction Process Server” 130. The Alias Process Server is protected by our first Air Gap 122 process and the Transaction Process Server is protected by our second Air Gap 122.

Data Splinters are randomly queried personal information provided by the consumer. The queried data “Splinter” is provided only on request of a system generated email, text message, social media or cell phone prompt to the consumer. The data collected is purposely not a complete thin piece of data; it's just a “Splinter” of data that is identified with a tag, such as a customer's commercial association number as one Splinter of data collected on the Internet 104, then a request generated for another Splinter with a tag for the customer's bank account number by a text message. The two Splinters of data are not simultaneously gathered nor are they stored in an accessible media (the media is protected by the Air Gap 122.

An example of a data Splinter follows. The name and email address of the consumer can be a data Splinter and can be provided through a financial institution or direct by the consumer on a website. This can be generated as, for example, a first request for data as part of an internet marketing site.

Another example of a Splinter of data is information that is randomly queried via the Exchange Server 112 as an email or text message or social media. Information can be provided, for example, on a second request for information with a key code generated by the Alias Process Server 120 transmitted to the Exchange Server 112. As an example, a street address only may be generated and provided.

These random Splinters of information can continue to be requested until a person's profile resides on the Alias Process Server 120 with the following criteria: no two pieces of information are on the Exchange Server 112 simultaneously; nor are there two pieces of information on the Threat Server 126 simultaneously. All information that is gathered is verified and matched with key codes and passed through the Threat Server 126 and checked for any viruses, malware, hijacks, and hack attacks before being transferred to a secure hard drive and then by Intelligent Robotic 124 means Air Gap 122 to the Alias Process

Server. Once the identity is created on the Alias Process Server 120, the person's identity will be given an “Alias” graphic representation and graphic code and become an “Identicon” while their personal profile if sent via a secure hard drive through a second Air Gap 122 Intelligent Robotic System 124 to the Transaction Process Server 130.

In addition, the Exchange Server 112 can act as a sign up mechanism between the consumer and a Financial Institution. The payment processes which servers (such as 130) perform are unique to the Invention. Access to this payment process is dependent upon the consumer having a relationship with a member Financial Institution. The Exchange Server 112 makes this possible either by the Financial Institution signing up the consumer or the Exchange Server 112 matching a consumer to a member Financial Institution. This relationship is important to the system because it is where the image is captured for the “Identicon” and there is verification of that image through the system by the Financial Institution, verifying the person's identity with multiple forms of identification and creating an account relationship with the consumer. The account relationship can be a checking or savings account extended by the Financial Institution with a line of credit attached to it or it can be a credit card issued by the Financial Institution with a line of credit attached to it. Either way, this will enable the consumer to make a secure purchase from a member merchant.

The consumer's picture which becomes the foundation of the “Identicon” is taken at the Financial Institution at the time of sign up and is transmitted as a Splinter of information through the system to reside on the Alias Process Server 120 and the Transaction Process Server 130.

The Mail Server 110 is important to the Invention because it is the query Server for all the Splinters of information, when directed by the Alias Process Server 120 to gather an additional Splinter of information from the consumer. The Mail Server 110 is like an “in and out” box for randomly gathered information. It is the first level of protection when gathering information. Information sent from and to the consumer is done through a secure environment with a 128 bit encryption protocol and is protected by “off the shelf” security system and hardware firewall. At the time of the transaction request by the Mail Server 110, the consumer has been given an “Alias” key code by the Alias Process Server 120. The consumer is not identified in any transactions as a “real” person. They have become an “Identicon”, a number and a key code (alphanumeric) encrypted transaction code with no identity thus protecting their identity. The person will know that the information being requested is meant for them by their visual “Identicon”. The “Identicon” cannot be lost or stolen because it is only a graphic representation of the individual consumer.

Information found on the Mail Server 110 in a Splinter might be expressed like the following example: Key Code Cedar Rapids, IA Once this piece of information has been off loaded through the system through the Server, the Alias Process Server 120 may request an additional Splinter of information Key Code(zip code) 52402. The Alias Process Server 120 may request an additional Splinter of information (address) 600 Blairs Ferry, the Alias Process Server 120 may request an additional Splinter of information Key Code 1234567 (commercial bank account number). Once these randomly collected pieces of information are transferred to the Alias Process Server 120 with the Key Codes and then processed through the Air Gap 122 and end up on the Transaction Process Server 130, an identity is created for the person who originally had their “Identicon” with their name, email address and photo transmitted through the Exchange Server 112 so it would look as follows at this point on the Transaction Process Server 130.
John Doe
johndoe@emailaddress.com
photo
street number Blairs Ferry
Cedar Rapids, Iowa
52402
1234567 (commercial bank account number)
At this point the Transaction Process Server 130 is waiting for several Splinters of information yet to be generated by the Alias Process Server 120 and queried by the Mail Server 110. The Mail Server 110 functions like the Exchange Server 112 since the information that it gathers may or may not be essential to the process of creating payment transactions. The processes that are performed by the Mail Server 110 are triggered by the Alias Process Server 120 which programs are protected behind the Air Gap 122 and the Threat Server 126. These two servers (120, 126) are in the Processing Center of the company and protected by firewalls, both hardware and software and higher levels of security.

The Mail Server 110 can communicate with several levels of devices. They can include as follows: The Mail Server 110 can query email messages to the customer's email address. These messages are coded by a Key Code. When the customer receives an email, they will be directed to a web page on the Mail Server 110 where they will answer the security request for information. The response is what we refer to as an In System Response and can be processed through the system within a matter of seconds and waits to be cycled by the Air Gap 122 through the Alias Process Server 120 which typically happens within an hour and within the next hour is available through the Alias Process Server 120 to the Transaction Process Server 130.

The Mail Server 110 can also send a text message through a third party system requesting another Splinter of information. The information travelling through the third party system is secure and is sent to the Mail Server 110 as an Out of System Splinter of data. That means it is generated outside of a Cloud and internal systems with a Key Code. When it is received by the Mail Server 110 the random Splinter of information is only identified through the process as an encrypted string of data. Any hacker or security threat would find it only as meaningless ones and zeros. And if thousands of Splinters of this data would be hacked, it would only be meaningless data. Because it is being accumulated on the internet Exchange Server 112 where it is being backed up and saved, if the system would undergo a major disruption the information can be recovered quickly and sent through the process of decoding and scanning for viruses and threats without exposing the consumer.

The system 100 may also gather Splinters via social media as well as a request for a selfie to verify the “Identicon's” identity. Using facial recognition the photo obtained by the Financial Institution and the selfie should match. This would add an enhanced level of security to the system 100. Although facial recognition has been used for years in security applications, the system's use of this would be strictly for verification of information coming from the Financial Institution. The Mail Server 110, as a part of the Invention, is critical to the process and although its function is simple it's essential to the overall security of the customer and their “Identicon”.

The Splinters of data collected are passed through the Air Gap 122 with their tags and are processed by the secure servers (such as 130) and create the customer's “Alias Identity” completely off grid, random Splinters of data one at a time until the total identity is collected, built and stored “Off Grid”. “Identicon's” are visually distinct Digitized 2D Graphical geometric images that can be derived from an IP address. “Identicons” can associate a particular user with a geometric representation. An attacker to an account will have an “Identicon” created that is different from the owner of the account. The “Identicon” is a Digitized 2D Graphical representation of the “Alias Identity” which is stored in the form of a “QR Token” along with the transaction key code for transmittal and verification of a payment transaction.

The Alias Process Server 120 creates the “Alias Identity” (The “Identicon”) The “Identicon” is used to create transactions that are controlled by the exchange server and transmitted through the Invention and its two proprietary Air Gap 122 and its various encryption and decryption elements before it is passed to the transaction process server.

The elements include the transaction moving from the Exchange Server 112 through the first Firewall 125 being scanned for viruses and malware on the Threat Server 126 and verification of the Key Code before being loaded on a Hot Swappable drive. The transactions are then loaded on the first Hot Swappable drive 122, Intelligently and Robotically 124 moved and plugged into the Alias Process Server 120 where they are decrypted and their “Identicon” is identified in the data base and the Key Code is analyzed and loaded on the second Hot

Swappable drive 122 then Intelligently and Robotically 124 removed and plugged in to the Transaction Process Server 130.

The Transaction Process Server 130 decrypts the information stored on the Hot Swappable Drive 122 from the Alias Process Server 120, and creates a customer transaction by matching an “Alias” customer record with an “Authentic” customer record by the Inventions encrypted Key Code. The Transaction Process Server 130 manages text notification of transactions and customer authorization.

Payments can be in the form of a debit from an on file bank account residing at a member financial institution or a Payment is sent to a debit or credit card with a member financial institution to pay a merchant for the purchase transaction. Payment transactions are encrypted and recorded to an off-site backup server. A Firewall 134 may protect the Transaction Process Server 130 from connection to the backup server.

The Threat Server 126 can have both outbound and inbound purposes.

Outbound Purpose of the Threat Server

The Threat Server 126 can be isolated from a public Internet 104. It can also be a first line of defense against outside threat. For example, a Firewall 125 may be placed between the Threat Server 126 and the Mail Server 110, and the Firewall 125 may also be between the Threat Server 126 and the internet Exchange Server 112, which may isolate the Threat Server 126 from any internet connection.

As an Outbound Server which resides in the companies Back Office 108, the Threat Server 126 is continually looking at the Alias Process Server 120 for instructions to create a query for personal data to be transacted by the Mail Server 110. It is the purpose of the Alias Process Server 120 to construct an “Alias” for a consumer's identity. It does so by sending a request for query information through the Air Gap Process 122 to the Threat Server 126. The Threat Server 126 then creates a query for information that will result in the Mail Server 110 gathering a piece of data, encrypting it with, for example, HMAC-MD5 protocol (see description below of this protocol) and then storing it for a query by the Threat Server 126 as inbound information to be processed in the first step of customer conversion to an “Alias Identity”.

The Inbound Purpose of the Threat Server

As discussed above, the Threat Server 126 does not reside on the public Internet 104 but in the companies Back Office 108. It can be protected by both hardware and software Firewalls (such as 125) and can be a unique part of the Invention both as hardware and software. The purpose of the Threat Server 126 is to gather information from the internet via querying the public servers 104 in a random, methodical, systematic yet simple and efficient method.

The Firewall 125 for the Threat Server 126 can be a third party firewall that, in itself, is a protective device for the personal information of clients and other data used by the Invention.

The Threat Server 126 can gather from the public Internet 104, the Splinters of information that are resting in the Mail Server 110. The information in the Mail Server 110 is not sent to the Threat Server 126 or is not available to the Threat Server 126 until the information is queried through a pinhole in the hardware Firewall 125. Because the information is randomly gathered, no one or no hacker or hacking process can know when the pinhole will be opened and information queried from the Mail Server 110. The process itself, by its spontaneous, random inquiries and security protocols create the first step to methodically removing information about a customer's personal data.

Once the information is gathered from the Mail Server 110 through the hardware Firewall 125, it is ready for an evaluation. Because the information was gathered using an encrypted security key, the Threat Server 126 evaluates the security key and authenticates it using, for example, the HMAC-MD5 encryption protocol. Using this protocol, along with the collecting of the information as Splinters of random data, the information presents itself as having no meaning.

This random information is then scanned for viruses, malware, security threats by third party security protection software. This process cleanses the information and prepares it to be entered on a hot swappable data collection system where it awaits transport by the first Air Gap Process 122. The Robotic Removal System 124 can dislodge a hot swappable drive from the Threat Server 126 and intelligently move the information within the storage device onto the Alias Process Server 120. At the point of information travelling Robotically 124 from the Threat Server 126 to the Alias Process Server 120, (The Air Gap Process 122) the information becomes secure and not vulnerable to attack or hacking from computers attached to the internet. The Splinters of information, even if hacked at this point in time, are meaningless and random Splinters of information with no form and are encrypted.

The following describes a process of the first piece of collected, random data from the Exchange Server 112 moving through the Threat Server 126 until the information resides for the first time on the Alias Process Server 120.

1. A customer finds a website, such as, for example, EZgopay.com on the internet or “aliasidentity.com” and after deciding to create an account, the customer enters, on the system, for the first time, their name and email address. This information is followed by an explanation of the process sent to the customer's email address by the Exchange Server 112. The process is explained to the customer that we will be gathering random, Splinters of information via several queries by multiple public devices these are stored on the Mail Server 110. The customer can acknowledge the email by accepting the terms and conditions of a contract and by answering “yes” to proceed. A call is sent to the Threat Server 126 and The Name and Email address is encrypted and stored on the Mail Server 110.

2. At this time the information is queried by a call issued to the Threat Server 126 and a pinhole is opened up in the Firewall 125 and the Threat Server 126 downloads the first Splinter of information containing the customer's name and email address which has been encrypted.

3. Once behind the Firewall 125, the information is assigned a position of status from 1-10 of importance to be transmitted through the Air Gap Process 122 to the Alias Process Server 120, One being information in Client Profile Development through Ten being the highest request for information which is a pending financial transaction. Based on the priority the information is stored on a hot swappable drive where, based on priority, the information is transferred to the Alias Process Server 120.

Definitions for the Invention

The Intelligent Robotic 124 removal and insertion device is a Robotic Arm 124 that is programmed by our proprietary software. The device on command from a call by the Alias Process Server removes or inserts hot swappable drives to the appropriate location in server 126, 120 or 130.

The System Calls are unique and an important part of the Invention. They are secure and they are the way the system controls traffic control between the Internet 104 and the Back Office 108. They also control the intelligent removal and insertion of the systems hot swappable drives from secure server to secure server.

The Pinhole in the hardware Firewall 125 is a construct of the system. It is like an orifice that opens only when a call is issued by the system. It is opened only for a specific amount of time to gather a specific amount of information from the Mail Server 110 and return that information to the Threat Server 126. The Pinhole is specifically one way. It pulls information from the Internet and is not vulnerable to attack because it opens and closes randomly. Information coming through the Pinhole from the Mail Server 110 has been scanned by third party software for viruses and malware prior to a call being issued for the information being passed through the Pinhole.

HMAC-MD5 is a protocol for encryption that centers on the use of encryption keys that can be verified using check digits so that information gathered can be identified and authenticated by the code itself. If the key is invalid then the information is authenticated. Inside the HMAC code the Invention uses a unique cipher to create the code. The cipher changes upon being issued and only exists one time. When the Splinter of information is gathered and is deemed usable by the Alias Process Server 120 as transmitted by the Threat Server 126 then the code is destroyed and an “Alias” is assigned. At that time the information only exists on the Alias Process Server 120 behind the Air Gap Process 122. All information is erased on the Threat Server 126 and the information is never referred to on the Threat Server 126 and is not recallable.

The Splinter of information as it relates to the Threat Server 126. When the information comes to the Threat Server 126, the Threat Server 126 has already assigned it a secure path by giving it an HMAC sequence. The Mail Server 110 appends the HMAC number issued by the Threat Server 126 and stores it to be transmitted upon call from the Threat Server 126. The Splinter of information is meaningless to anyone obtaining it maliciously although in the most unsecure of situations if the information was obtained it can be destroyed and because the Threat Server 126 has given it its distinct HMAC number it can be required by initiating the process from the beginning.

Alias Process Server.

The Alias Process Server 120 may be described as a hub of the Invention. The Alias Process Server 120 is where the “Identicon” is created and stored. The Alias Process Server 120 also is where the calls are generated to create the “Identicon” and it is the gate keeper for the Transaction Process Server 130.

The “Identicon” Creation: The creation of the “Identicon” is an essence of Invention and the ability to keep this “Identicon” off grid by the Process yet let the “Identicon” make normal transactions in the real world is a key to the Invention and the Process.

The Alias Process Server 120 gathers information by creating calls. The calls are for Splinters of information. The Alias Process Server 120 sends these calls through the Process to the Threat Server 126 then to the Mail Server 110 from behind a first Air Gap 122. The ten calls of information create the “Identicon” but the Alias Process Server 120 stores a specific set of information. This set of information is coupled with the real world's physical picture of the consumer and a QR code is created for use by the Exchange Server 112 to authenticate the consumer to the merchant or financial institution.

The Alias Process Server 120 assigns a unique cipher to the “Identicon” which is used by the Threat Server 126 when creating the HMAC-MD5 code. The cipher, when created by the Alias Process Server 120, is also passed to the Transaction Process Server 130 through a second Air Gap. This one time cipher, for the “Identicon”, is used by the Alias Process Server 120, to create the data base of encrypted data coming from the Threat Server 126. Once the cipher is created once and stored in the data base, it is never used again for any other “Identicon”, so as the information travels through the system and the process, random information can be paired and synchronized in the Alias Process Server 120 for transmission through the Air Gap to the Transaction Process Server 130.

Generating the Calls: The Alias Process Server 120 generates random calls for the ten Splinters of Information that are required to create the consumer behind the second Air Gap 122 on the Transaction Process Server 130. To further protect the Transaction Process Server 130, the calls are generated by creating chaos in the collection of the Splinters of Information through to the Mail Server 110.

### EXAMPLE

| johndoe@hotmail.com | janedoe@yahoo.com |
|---|---|
| John Doe | Jane Doe |
| City | Account Number |
| Address | Credit Limit |
| State and Zip Code | City |
| Credit Limit | Credit Card Number |
| Phone Number | Address |
| Password | Phone Number |
| Account Number | State and Zip Code |
| Credit Card Number | Password |

By collecting information randomly with no synchronization except for the cipher that was uniquely created for each of these, as these Splinters of Information are randomly called and encrypted, anyone wanting to hack the information would get chaos within the data that they would hack, steal and gather because there is no association between the Splinters of Information and the consumer until that information is constructed behind the second Air Gap 122 on the Transaction Process Server 130.

The gateway to the Transaction Process Server 130.

The Alias Process Server 120 is the data base for the “Identicon” identity. The “Identicon”, after it is created, resides on the Alias Process Server 120. Each

“Identicon” is unique because of the data that is randomly selected to be stored with it. The data stored with each “Identicon” creates the cipher with the key that is passed to the Alias Process Server 120 to create the connection between the real world person, which will be stored on the Transaction Process Server 130 and the “Identicon”.

### EXAMPLE

| johndoe@hotmail.com | janedoe@yahoo.com |
|---|---|
| John Doe | Jane Doe |
| City | Account Number |
| Address | Credit Limit |

Based on the character length of the two preceding examples and the information the “Identicon's” are created. They each are different and unique when compared to a real world person. Splinters of information will match once encrypted and allow for the match to be perfect each time a transaction is created. The extra security that is part of the “Identicon” file in the Alias Process Server 120 is a photo obtained in the process of creating the “Identicon”. The photo, when matched with the Splinters of information above and presented to the merchant at the time of the financial transaction inside the QR code, creates the transaction that will be passed through the Invention to the Transaction Process Server 130.

Once the Alias Process Server 120 creates the “Identicon”, it is exported out to be stored on the Exchange Server 112. Once stored on the Exchange Server 112 calls can be issued for authentication by merchants to create financial transactions. When a call is issued by a merchant the “Identicon” is sent for authentication of the transaction. When the transaction occurs the merchant accepts the QR code as authentication for the transaction. As he opens the QR code on his internet connected system he will see the person on his monitor and authenticate the person with the “Identicon” thus accepting the unique transaction code stored one time within the QR code.

Transaction Process Server.

The Transaction Process Server 130 is the last link in the Invention. It serves multiple purposes within the Invention. It stores the Splinters of information about the consumer for the purpose of creating a financial transaction, and it is the only place that these Splinters of information are gathered in one place together and only at the time of creating the transaction. In addition, it is where the algorithms for decryption are stored and where the HMAC-MD5 is used as the key to unlock the decryption of the Splinters of information coming from the Invention. Also, it is where batch files are created for export to a secure FTP 136 site so that the financial institutions can implement their internal processes to decrypt the transactions either credit card or ACH and create the consumer's transaction.

Using the Splinters of Information to Create a Financial Transaction.

The Transaction Process Server 130 is where the real world identity of the consumer is stored for creating a financial transaction. This real world data consists of ten Splinters of information that create the transaction as described in the Alias Process Server 120 application. And secure Splinters of information are collected through the process and only stored on the Transaction Process Server 130. These Splinters of information are undisclosed personal information about the consumer that only they would know and are used only during the decryption process and in case of a security threat to the consumer's ID. These questions can be forced to be answered for authentication of a transaction if a threat is deemed imminent. In this situation a call would be generated by the Exchange Server 112 and an out of system notification and verification from the Transaction Process Server 130 to the consumer's cell phone. This message would have to be answered correctly for the transaction to occur. It is the only time the Transaction Process Server 130 communicates as part of the Invention to the real world. The answer is passed directly to the Transaction Process Server 130 as an inbound communication by a third party processor of text transactions from their secure server.

Algorithms for Decryption:

To create the transaction the HMac-MD5 key that was created in the Alias Process Server 120 is matched to the Splinters of personal information through our algorithm. To give an example of how this is done, think of the stored information being randomly stored on wheels as in a slot machine. The algorithm spins the wheels looking for matching keys. As a match is found on each wheel, they align and only when all ten pieces of information align is the transaction created. This is an over simplification of the process because the key is made up of encrypted strings of information and the cipher that decrypts the data and the placement of the information within the tables.

A purpose of the Invention is to be a hacker proof system. The Invention itself is new and patentable. Nothing like the Invention exists in its totality. The cipher on the Transaction Process Server 130 is unique for each transaction between the consumer and the merchant. The cipher then creates the key which is unique with each transaction between the consumer and the merchant and the key creates the path through the Air Gaps 122 to make the transaction flow through the Invention at the same time as making it unhackable.

Batch File Creation for Export

The Invention creates Batch Files for processing by Financial Institutions as part of their regular course of business. The Batch Files are created in a secure FTP 136 environment. The Financial Institutions are sent a key that corresponds with the batch number for their daily processing. One unique key is generated for each financial batch sent to the Financial Institution. If five batches are created in a given period, five keys will be created for decryption of the batches.

The batches are sent to a third party FTP 136 site for the bank 140 to pull. The Financial Institution will randomly access the third party FTP 136 site, identify their file and download it to their site. Once it is behind the bank's secure Firewall, the encryption key will be used to decrypt and unlock The File Lock 138 the financial information and make the proper merchant transactions with, for example, a customer credit card account 142. Thus ends the process of Splintered information from a consumer, securely creating a financial transaction that is threat protected and uniquely secured. The consumer, through their “Identicon”, can create secure transactions and if a merchant's system is exposed to a security breach, the “Identicon” protects the merchant and customer since it has no customer identity attached to the “QR Token” which is the embodiment of the transaction. The “QR Token” with its one time use encrypted transaction to the hacker becomes only a meaningless string of information. Transactions are changed and recreated randomly at will by the Invention while leaving the personal information for the consumer secure behind the hardware elements, software algorithmic equations and encryption technology of the Inventions and most significant use of robotics in developing the Inventions Air Gaps 122 that are virtually impenetrable.

The above description can be modified without departing from the scope of the claims.

1. A method of encrypting an identity for financial transactions including:
creating an alias for the identity on an alias computer server with both a graphical component and a textual component.
creating a hardware firewall between an internet server and the alias computer server;
creating a software firewall between the internet server and the alias computer server;
creating air gaps between the internet server and the alias computer server.
utilizing the alias in financial transactions with a financial institution.
creating the graphical component as a quick response token;
sending the quick response token with a mobile device to a merchant;
displaying the alias for the identity when the merchant scans the quick response token; and
the merchant visually approving the alias.

2. The method of claim 1, including:
generating the identity from the alias; and
a financial institution debiting an account assigned to the identity.

3. The method of claim 2, wherein the alias is created with splinters of information from random events through a plurality of electronic devices.

4. A system of encrypting an identity for financial transactions including:
an alias computer server configured to create an alias for the identity with both a graphical component and a textual component;
a threat server configured to encrypt the alias with splinters of information from random events through a plurality of electronic devices;
a hardware firewall between an internet server and the threat computer server;
a software firewall between the internet server and the threat computer server; and
a plurality of air gaps between the internet server and the alias computer server.

5. The system of claim 4, wherein the alias is utilized in financial transactions with a financial institution.

6. The system of claim 5, including:
the graphical component configured as a quick response token;
a mobile device configured to send the quick response token to a merchant; and
an electronic device display configured to display the alias for the identity when the merchant scans the quick response token.

7. The system of claim 6, wherein the alias server is configured to generate the identity from the alias.

8. A system of encrypting an identity for financial transactions including:
an email server configured to collect information regarding the identity;
an alias computer server configured to create an alias for the identity with both a graphical component and a textual component,
a threat server configured to encrypt the alias with splinters of information from random events through a plurality of electronic devices;
a hardware firewall and a software firewall disposed between an internet server and the threat server;
a transaction server configured to complete a financial transaction request received from the alias server; and
at least one air gap between the internet server and the threat server, and at least one air gap disposed between the alias server and the transaction server.
